(19) United States
(12) Patent Application Publication
(10) Pub. No.: US 2015/0166861 A1
(43) Pub. Date: Jun. 18, 2015

(54) TWO COMPONENT (2K) LAMINATION ADHESIVE

(71) Applicants: Henkel AG & Co. KGAA, Duesseldorf (DE); Mitsubishi Gas Chemical Company Inc., Tokyo (JP)

(72) Inventors: Holger Eichelmann, Duesseldorf (DE); Hanns Misiak, Haan (DE); Christina Huebner, Langenfeld (DE); Michael Hoeltgen, Duesseldorf (DE); Daniela Neitzke, Duesseldorf (DE)

(21) Appl. No.: 14/627,444

(22) Filed: Feb. 20, 2015

Related U.S. Application Data
(63) Continuation of application No. PCT/EP2013/066412, filed on Aug. 5, 2013.

(30) Foreign Application Priority Data
Aug. 23, 2012 (DE) 102012215027.7

(51) Int. Cl. C09J 177/06; B32B 29/00; C09D 177/06; B32B 7/12; C09J 123/06; C09D 123/06

(52) U.S. Cl. CPC C09J 177/06; C09J 123/06; C09D 123/06; C09D 177/06; B32B 7/12; B32B 29/005; B32B 2250/02; B32B 2255/26

(57) ABSTRACT

A two-component composition consisting of a component A comprising epoxides having a number-average molecular weight (Mₙ) of 150 to 5000 g/mol and at least 2 epoxide groups per molecule, a component B comprising a reaction product prepared from araliphatic polyamides and optionally further amines, unsaturated carboxylic acids and/or derivatives thereof and aliphatic and/or aromatic polyepoxides in a molar ratio of amine to the sum total of unsaturated carboxylic acid and/or derivatives thereof and polyepoxide of 1:0.4 to 1:0.95, to give a product having primary amino groups and having a number-average molecular weight (Mₙ) below 5000 g/mol.

The invention relates to a crosslinking two-component binder based on an epoxide component and an amine component, wherein the amine component has an increased number of polar groups. The invention further relates to a two-component lamination adhesive and a two-component coating agent which contain this binder system and are suitable as a barrier coating.

U.S. Pat. No. 7,282,543 describes a water-based composition containing a polyepoxide resin having at least one tertiary amino group, wherein the amino group has one or two substituents, each bearing an epoxy group. Aqueous polyamino compounds are described as the crosslinking agents.

EP 1086 190 describes a reactive system for film substrates comprising an epoxy resin based on bisphenol A, bisphenol F, resorcinol or aliphatic polyols with epoxy groups as well as a crosslinking agent based on compounds containing amino or carboxyl groups. No crosslinking agents containing aromatic groups are described.

EP 1219656 describes a coating composition having gas barrier properties, wherein one component is an epoxy resin which has at least one epoxyamine unit and is a derivative of meta-xylylenediamine (mXDA), and the curing agent is a compound from reaction of XDA with monocarboxylic acid as well as polyfunctional compounds, which then form an amide group.

EP 1437393 claims an adhesive having an epoxy resin component and a curing agent for this epoxy resin component, wherein the cured reaction product of the epoxy resin and the curing agent contains at least 40% by weight of XDA structures. The exemplary embodiments have a high content of XDA structures with 57 to 60% by weight, based on the cured adhesive composition. The curing agent component bearing amino groups is produced by reaction of mXDA and methacrylic acid. Aliphatic and/or aromatic polyepoxides are not used. The molecular weight of the curing agent component is not disclosed.

WO 2011/000619 describes two-component epoxy adhesives containing a high proportion of aromatic structures. A reaction product of an excess of aromatic diamines with epoxides is produced as the amine component, which should preferably also contain monomeric aromatic diamines.

In general, mXDA or pXDA is used as the crosslinking agent in the two-component coating agents of the prior art. These are primarily araliphatic amines. Araliphatic amines consist of at least one aromatic ring and at least one aliphatic radical, in which the amino groups are present not bound directly to the aromatic ring, but instead, bound directly to the aliphatic radical, and therefore behave chemically like amino groups of aliphatic amines. These amines can migrate into the film materials under various environmental conditions. Therefore, these low-molecular amines should preferably not be present, or should be contained only in reduced amounts, in adhesives that may come in contact with foods in the adhesively bonded product.

Another disadvantage of the systems described above is that, in practice, the coatings must have good adhesion to various substrates. Since a variety of different substrates are used for such packages, it is advantageous for the adhesive to have good adhesion to various polar or nonpolar substrates. It is also advantageous if an adhesive having a low viscosity is used. Furthermore, a high degree of brittleness and/or fragility is often observed with the above-described systems. Thus, the flexibility required for use in the area of flexible packagings is not achieved. Furthermore, the pot life is often too short.

The object of the present invention is therefore to provide a two-component composition composed of an epoxide and low-viscosity amine reaction products, the aim being to reduce the amounts of unreacted amine compounds. The aim is to obtain flexible adhesive layers, and for the pot life to be adequate. A further subject matter of the invention relates to two-component lamination adhesives or two-component coating agents based on the two-component composition. A subject matter of the invention relates to the use of such coating agents to produce coated films having only low permeability to gaseous or diffusible substances, for example, for oxygen or flavorings.

This object is achieved by providing a two-component composition composed of a component A containing at least one epoxide having a number average molecular weight (M_{N}) of 150 to 5000 g/mol with at least two epoxy groups per molecule, a component B containing a reaction product produced from at least one araliphatic polyamine and optionally one or more additional amines, at least one unsaturated carboxylic acid and/or a derivative thereof, preferably unsaturated carboxylic acid esters, and at least one aliphatic and/or aromatic polyepoxide, preferably diepoxide, in a molar ratio of amine to the sum total of unsaturated carboxylic acid and/or its derivatives and polyepoxide of 1:0.4 to 1:0.95 for a product containing primary amino groups and having a number average molecular weight M_{N} of less than 5000 g/mol.

One ingredient of the two-component composition according to the invention consists of component A, which contains at least one epoxide, for example a polymer or an oligomer based on polyesters, polyamides, poly(meth)acrylates, polyurethanes, polyureas, polyolefins, polycarbonates or aromatic and aliphatic polyepoxides. According to the invention, it is necessary for these epoxides to contain two or more epoxy groups per molecule. The various epoxides are also referred to below as epoxide building blocks or polyepoxides. If the epoxide is a polymer, the epoxy groups may be incorporated directly during the polymer synthesis via epoxy-functional starting compounds. Alternatively, it is possible that in a polymer having double bonds, these are converted to epoxy groups. Another possibility is to react polymers having OH groups or isocyanate groups as the base polymer with low-molecular epoxide compounds, which additionally have a group that is reactive with the OH group or the isocyanate group. Such reaction processes or polymer-analogous reactions are familiar to those skilled in the art.

OH-functionalized polyolefins are one class of suitable base polymers. Those skilled in the art are familiar with polyolefins, which can be produced in many molecular weights. Such polyolefins based on ethylene, propylene or higher-chain a-olefins as homopolymers or copolymers can be functionalized either by copolymerization of monomers containing functional groups or by graft reactions. Other olefin (co)polymers such as ethylene-acrylate copolymers, for example, may also be used.

Further olefinic polymers that are suitable as base polymers for producing component (A) include, for example, homopolymers or copolymers of 1,3-butadiene, 2-methyl-1,3-butadiene (isoprene), 2-methyl-1,3-hexadiene, 2-methyl-1,3-cyclopentadiene and further copolymerizable monomers.

Polyester polyols are another class of suitable base polymers. These can be produced by polycondensation of one or more polycarboxylic acids and a mixture of polyols. Suitable polycarboxylic acids include those having an aliphatic, cycloaliphatic, aromatic or heterocyclic base body or their acid anhydrides and esters. A variety of polyols may be used as the polyol for reaction with the polycarboxylic acids. Examples include aliphatic polyols with two primary or secondary OH groups per molecule and 2 to 20 carbon atoms, for example, also polyether polyols. Such polyester polyols are also commercially available.

Another class of base polymers contains a polyamide backbone. Polyamides are the reaction products of diamines with di- or polycarboxylic acids. Through targeted synthesis it is possible to introduce terminal OH groups into polyamides.

Another class of base polymers is polyols based on acrylates. These are polymers produced by polymerization of (meth)acrylic esters, such as esters of acrylic acid, methacrylic acid, crotonic acid or maleic acid. Preferably the customary C₁ to C₁₅ alkyl esters of (meth)acrylic acid are polymerized. Monomers having OH groups may also be present. Optionally, other copolymerizable monomers may also be included. Those skilled in the art are familiar with suitable OH-functional poly(meth)acrylates. Another approach directly results in acrylate polymers having epoxy groups. Monomers containing glycidyl groups are then polymerized into the product.

OH groups of the aforementioned base polymers can be reacted with low-molecular compounds containing an epoxy group as well as a group that reacts with the OH group, according to known methods. Examples of such groups include NCO groups, halogens, anhydrides or esters. Polymers containing epoxy groups are obtained after the reaction.

Polyurethanes are another class of suitable base polymers. These can be produced by reacting polyols, in particular diols and/or triols, with diisocyanate or triisocyanate compounds. The quantity ratios are selected to yield NCO-functionalized prepolymers in the terminal position. In particular, the polymers should be linear, i.e., produced predominantly from diols and diisocyanates. The polyols and polyisocyanates that can be used in the synthesis of PU polymers as well as suitable methods for synthesis are familiar to those skilled in the art. The amount of isocyanates is selected to be in stoichiometric excess so that NCO-functional PU prepolymers are obtained. The isocyanate groups may then be reacted with alcohols containing epoxy groups.

The base polymers mentioned above may contain multiple epoxy groups. Individual polymers or mixtures may be used. However, it is necessary according to the invention for an average of two or more epoxy groups to be present. The resulting polymers or oligomers containing epoxy groups are suitable as component (A) within the context of the invention.

Furthermore, the known polyepoxide resins having at least two epoxy groups per molecule are also suitable as epoxides. The polyepoxides may in principle be saturated, unsaturated, cyclic or acyclic, aliphatic, alicyclic, aromatic or heterocyclic polyepoxide compounds. Examples of suitable polyepoxides include the known polyglycidyl ethers, which are produced by reaction of epichlorohydrin with a polyphenol in the presence of alkali. Suitable polyphenols include, for example, resorcinol, pyrocatechol, hydroquinone, bisphenol A (bis(4-hydroxyphenyl)-2,2-propane), bisphenol F (bis(4-hydroxyphenyl)methane) or 1,5-hydroxynaphthalene. It is also possible to react corresponding amine-substituted compounds to form epoxy resins. Aliphatic polyols, for example diols, may likewise be reacted to form epoxide compounds. Examples include ethanediol diglycidyl ether, butanediol diglycidyl ether or diglycidyl ethers of polyethers having a molecular weight of up to 500 g/mol. In particular, epoxy resins that are flowable at room temperature and which generally have an epoxide equivalent weight of 70 to about 500 g/mol epoxide are used.

In one particularly preferred embodiment, component A comprises, at least in part, epoxide building blocks which have an aliphatic or substituted aliphatic chain. These may also be mixtures of aromatic epoxy resins with those based on the above-mentioned polyacrylates, polyurethanes, polyesters or polyolefins, or in particular with aliphatic polyepoxides.

The polyepoxides of component A that are suitable according to the invention should have an average of two to 10 epoxy groups, in particular two, three or four per molecule. The polyepoxides may be present individually or as a mixture having different structures.

To obtain suitable application properties, the molecular weight of the epoxide building blocks (number average molecular weight, M_{N}, determined by GPC against a polystyrene standard) must be 150 to 5000 g/mol, in particular 200 to 2500 g/mol. Low molecular weights are preferred for solvent-free adhesives, but higher molecular weights may also be selected for solvent-containing systems.

The second component B which crosslinks with component A contains reaction products having aromatic nuclei and also primary amino groups and aliphatic substituents. These are produced as the reaction product of araliphatic polyamines and optionally additional amines, unsaturated carboxylic acids and/or derivatives thereof, and aliphatic or aromatic polyepoxides.

For example, compounds of the following formula are suitable as polyamines:

R¹-aryl-(—(CH₂)ₙ—NH₂)ₐ
where
R¹=H, C₁ to C₆ alkyl, in particular H
a=2 or 3
n=1 to 4.
   In particular aminoalkyl-substituted phenyl compounds or aminoalkyl-substituted naphthyl compounds are suitable, in particular di-substituted compounds. For example, di(aminomethyl)naphthalene and xylylenediamine (XDA), in particular mXDA, are suitable as the amine compound for further reaction.

Preferred unsaturated carboxylic acids are α, β-unsaturated carboxylic acids. In particular acrylic acid, methacrylic acid and crotonic acid are suitable. The corresponding unsaturated carboxylic acid esters are preferably used as the derivatives of unsaturated carboxylic acids. These include, for example, esters of acrylic acid, methacrylic acid or crotonic acid. The ester group may comprise aliphatic alcohols, for example, C₁ to C₈ alcohols. The unsaturated carboxylic acid and/or its derivatives is/are reacted with araliphatic polyamines. The corresponding reaction products must also have terminal amine groups.

In another embodiment of the invention, optionally at least one additional amine may also be present in this reaction or in a further reaction step. In this case as well, the corresponding reaction products must contain amine terminal groups. The additional amine is preferably an aliphatic amine, in particular a primary aliphatic amine. In one preferred embodiment, at least one primary amino alcohol may be reacted. The primary amino alcohols are compounds having a primary amino group and one or more OH groups. It is advantageous if the primary amino alcohol is an aliphatic amino alcohol. Examples include ethanolamine and butanolamine. The amount of polar groups, in particular the H bridge-forming groups in the crosslinked product, can thus be increased. The amount of amino alcohol is preferably selected so that up to 50 mol % of the araliphatic polyamine is replaced by the amino alcohol. The amino alcohol is thus preferably used in an amount of up to 50 mol %, based on the sum of the araliphatic polyamine and the amino alcohol. Ethanolamine is preferably used. Amine-substituted polyethers may also be used as primary aliphatic amines. Amine-substituted polyethers are preferably used in an amount of up to 90 mol %, based on the sum of araliphatic polyamine and the additional amines.

Polyepoxide compounds are another necessary component of the reaction product. These epoxide compounds cause a lengthening of the chain. These may be aromatic and/or aliphatic epoxides. The amount of epoxides is selected so that amine-terminated polymers/oligomers are still obtained after the reaction. In particular, the molar ratio of amine to polyepoxide may be from 1:0.05 to 1:0.5, in particular 1:0.1 to 1:0.4. Diepoxides are suitable and preferred.

The reactions of unsaturated carboxylic acids and/or derivatives thereof, in particular carboxylic acid esters with polyamines, and reactions of polyepoxides with polyamines, are familiar to those skilled in the art. The selected unsaturated carboxylic acids and/or derivatives thereof, in particular carboxylic acid esters, are mixed with the corresponding amount of the polyamine and reacted, optionally with heating. Volatile reaction products may optionally be removed. These amine-containing reaction products may likewise then be reacted with the polyepoxides. Those skilled in the art can determine suitable reaction conditions. It is also possible for the starting ingredients to be dissolved in nonreactive solvents for a better reaction. These nonreactive solvents can be removed by distillation, as needed, after the reaction, or a solvent-containing component B is obtained. The amounts of polymeric polyamines are reduced by the stepwise reaction control.

The compounds suitable as component B according to the invention have primary amino groups. The molecular weight of these compounds may be between approximately 500 and 5000 g/mol, in particular up to approximately 3000 g/mol (number average molecular weight, M_{N}, determined by GPC against a polystyrene standard). In one embodiment, both components are flowable. The viscosity may be less than 20,000 mPas (25° C., ISO 2555, Brookfield LVT). In another embodiment, organic solvents are present in at least one component, so that these may also be liquid components.

It is preferred according to the invention that epoxy building blocks having aliphatic chains are used in component B and optionally in component A. The amount of aliphatic epoxides, based on the amount of all epoxide building blocks, should preferably be from 10% by weight to 50% by weight, in particular from 15 to 40% by weight. If the amount selected is too low, the crosslinked composition is inflexible and brittle. If the amount selected is too high, the barrier properties are worsened. The aliphatic epoxy building block may be present in component A and/or in component B.

Two-component compositions according to the invention are to be produced from the suitable epoxide polymers as component A and the polyamino compounds of component B. The two components are mixed in the liquid state, wherein the ratio of primary amino groups in component B and epoxy groups in component A should be approximately equimolar. In particular, the molar ratio is approximately 0.75:1 to 1.25:1, in particular 0.95:1 to 1.05:1, to avoid an excess of unreacted amino groups. The two components are stored separately and mixed before processing. The ingredients are subsequently crosslinked.

Two-component adhesives can be produced from the compositions described above. In these adhesives, it is advantageous if additional ingredients are also present such as, for example, solvents, plasticizers, catalysts, stabilizers, adhesion promoters, pigments and/or fillers.

In one embodiment, the composition which is suitable according to the invention contains at least one tackifying resin. In principle, all resins which are compatible and which form a homogeneous mixture may be used. For example, aromatic, aliphatic or cycloaliphatic hydrocarbon resins may be used, as well as modified or hydrogenated versions thereof. The resin may be used in an amount of 0 to 50% by weight, preferably up to 20% by weight, based on the composition.

Additional soluble polymers may also be contained in the composition, such as polymers having gas barrier properties or flavoring barrier properties. Examples of such include polysaccharides, such as cellulose ethers or esters.

In addition, plasticizers may also be present, such as white oils, naphthenic mineral oils, paraffinic hydrocarbon oils, adipates, benzoate esters, vegetable or animal oils, and derivatives thereof. In particular, plasticizers that are safe for use in foods are suitable, for example, citric acid esters or short-chain triglycerides.

Phenols, high molecular weight sterically hindered phenols, polyfunctional phenols, and sulfur- and phosphorus-containing phenols or amines are suitable as stabilizers or antioxidants that may optionally be used.

It is also possible to add silane compounds as adhesion promoters to the composition. Adhesion promoters that can be used include the known organofunctional silanes, such as (meth)acryloxy-functional, epoxy-functional, amine-functional silanes or nonreactively substituted silanes. In one preferred embodiment, 0.1 to 5% by weight of these silanes is added to the adhesive. Depending on the choice of silane, it is advantageous to mix the silane into only one component. It is thus possible to prevent a premature reaction and a reduction in storage stability.

A composition may also contain catalysts as an optional additional additive. The catalysts used may include all the known compounds capable of catalyzing the reaction of amino groups and epoxy groups. Examples include metal compounds such as titanates, bismuth compounds, tin carboxylates or zirconium chelates, or amine compounds or their salts with carboxylic acids, such as nonvolatile alkylamines, amino alkanols, morpholine and derivatives thereof, polyamines such as triethylenetetramine, guanidine or 1,8-diazabicyclo[5.4.0]undec-7-ene (DBU). The catalyst may be used in an amount of 0 to approximately 5% by weight, based on the total weight of the adhesive, preferably 0.1 to 1% by weight catalyst.

A special embodiment of the invention may also contain pigments or fillers in the compositions. These are finely divided pigments having a particle size <5 μm, for example. One embodiment of the invention involves flaked pigments which may be dispersed in a component of the binder. Another procedure uses nanoparticles. which usually have a particle size <500 nm, in particular <100 nm. Those skilled in the art are familiar with such pigments or fillers, and can select these according to customary considerations and incorporate them into one or both binder components by using known methods.

In one embodiment, the composition may also contain solvents. These are the customary solvents which can evaporate at temperatures up to 120° C. The solvents may be selected from the group of aliphatic hydrocarbons, araliphatic hydrocarbons, ketones, in particular C₁-C₄ alcohols or water. In another preferred embodiment, the two-component composition is free of solvent.

One preferred embodiment is composed of a component A containing polymers with two or more epoxy groups, containing, alone or proportionally, aliphatic epoxy resins, based on component A. Component B contains a reaction product of an aromatic diamine with unsaturated carboxylic acid esters in amounts such that an amine-terminated intermediate product is obtained. This intermediate product is subsequently reacted with a mixture of aliphatic and/or aromatic diepoxides in a substoichiometric amount to yield an amine-terminated polymer. The composition should contain a total of 10% to 50% by weight aliphatic epoxide building blocks (based on the epoxide content).

It is possible to produce two-component adhesives or two-component coating agents from the two-component composition together with the additives.

Since the adhesives are suitable in particular for coating large surface areas, they should have a low viscosity at an application temperature of approximately 20° to 90° C. The viscosity of the adhesives according to the invention, measured after mixing the components, should be between 200 and 5000 mPas at the application temperature, preferably 300 to 3000 mPas, in particular at 20° to 60° C. (Brookfield viscosimeter LVT according to EN ISO 2555).

The known auxiliary substances and additives may be added to the component A or to component B in the two-component adhesives, provided that they do not react with the additives. Solvents may also be contained, but one special embodiment of the invention works without solvents. It is then possible to ensure through the choice of component A and component B that a flowable mixture of components A and B is obtained at room temperature, such as 25° C.

An adhesive according to the invention may be used in particular as a lamination adhesive. The adhesives are applied in a thin layer to a film. Immediately thereafter, any solvents that are optionally present should be evaporated. A second film is subsequently applied to the adhesive layer and pressed with pressure. Solvents may be omitted in a choice according to the invention of components having a low viscosity.

The known flexible films may be used as film materials for producing multilayer films. These are substrates of thermoplastic materials in film form, for example, polyolefins such as polyethylene (PE) or polypropylene (PP, CPP, OPP), polyvinyl chloride (PVC), polystyrene (PS), polyesters such as PET, polyamide, organic polymers such as cellophane; in addition, metallized films, films coated with SiO₂ or Al₂O₃, metal foils or paper are also possible as substrates. The film materials may also be modified, for example by modifying the polymers with functional groups, or additional components, for example pigments, dyes or foamed layers, may also be contained in the film. Colored, printed, colorless or transparent films may also be used.

In one special embodiment of the invention, a water-soluble two-component adhesive is provided. It is advantageous here if the components contain a greater number of polar groups in order to have improved water solubility or water miscibility. In this case, it is also advantageous to use emulsifiers or dispersants as additional ingredients. Even in small amounts, these assist with the dispersibility of the components in water. The emulsifiers should be added in amounts of 0.1 to 5% by weight, based on the composition. Ionic groups which result in long-term water solubility are not included. After crosslinking the two components, a network is formed. This network is no longer water-soluble, but it has good adhesive power and good barrier properties.

Another embodiment of the invention uses the two-component compositions for two-component coating agents. These coating agents may in principle contain the same ingredients as those described for the lamination adhesives. In making a selection, however, it is important to be sure that, after crosslinking, the coating agents do not have a smooth, nontacky surface. There should be good adhesion only to the substrate to which the coating agent is applied in liquid form. Those skilled in the art are familiar with such ingredients, which should be used only in a small amount by weight or should be avoided in the production of nontacky surfaces.

The subject of the invention likewise relates to a multilayer film which is bonded using a lamination adhesive which is suitable according to the invention; the known plastic films may be used as substrates. A continuous layer is produced on this film using an adhesive according to the invention, and is bonded to a second film of the same or different type immediately after application. In addition to the two-layer films, it is also possible to produce a multilayer film with additional work steps. One embodiment according to the invention works with transparent films, for which it is advantageous if the adhesive according to the invention is likewise transparent and is not discolored. In principle, other non-plastic films, such as paper or metal foils, for example, may also be used in multilayer films.

The adhesive according to the invention exhibits good adhesion between the different layers. It does not exhibit bubbles or defects in the adhesive layer. The resulting composite substrates are flexible. Cracks and delamination are prevented, even in the possible additional production steps as packaging.

The subject matter of the invention further relates to the use of the composition according to the invention to produce coatings on flexible composite substrates. The additives and auxiliary substances stated above may be contained in the coating agent. The coating agents are liquid, or may be applied in flowable form by heating to 90° C. These coatings are flexible after crosslinking, and therefore may be used in particular for flexible multilayer films. In one preferred embodiment, the coating agent according to the invention is applied at an application temperature between 20° and 60° C.

After crosslinking, layers that are not tacky at the surface are obtained. Such films may then be further processed in a known way, either being applied as additional lamination layers or being finished.

The composite films produced according to the invention have high flexibility. They may be transparent, i.e., containing only nanoparticles as fillers, or containing no fillers or only small amounts of customary fillers, so that the adhesive layer does not have an extremely cloudy appearance in the composite. However, these may also be colored or pigmented layers. A particularly advantageous property of the layers according to the invention is an elevated barrier effect of the layer. It has been shown that flavorings cannot permeate well through such multilayer films as the adhesive layer or as a coating, compared to conventionally adhesively bonded films. Improved stability against diffusion of gases such as oxygen or water vapor has also been confirmed. In addition, it has been shown that the amounts of unbound aromatic diamines in the adhesive layer are reduced by component B having the composition according to the invention.

The compositions according to the invention may be further processed to form two-component coating agents or two-component adhesives in a simple manner. Composite films having high barrier properties are obtained when these adhesives or coating agents are used on film substrates. The barrier properties may be based on various ingredients; for example, the diffusion of oxygen may be reduced. Another embodiment reduces the diffusion of water. In addition, it is possible to reduce the diffusion of flavoring substances from a package or into a package, for example.

Adhesion to the various substrate materials is good. No separation between adhesively bonded surfaces is observed, even with mechanical load on the composite materials, for example, the adhesively bonded films. For example, packaging can be produced from the composite materials according to the invention. Due to the barrier effect, such packaging is suitable for sensitive items such as foodstuffs or pharmaceutical goods. Another field of application is technical lamination adhesives, for example, adhesive bonding for flexible circuits or similar objects.

### EXAMPLES

### Example 1

354 g (2.6 mol) meta-xylylenediamine (mXDA) was placed in a flask and stirred. Ethyl acrylate (137.6 g, 1.375 mol) was added slowly at T=50-70° C. over a period of approximately 1 hour (ratio (molar): mXDA/Et-Acr=1:0.53). The temperature was kept at 70° C. for 15 minutes. The mixture was kept at 140° C. and the resulting ethanol was distilled off. T was subsequently raised to 170-190° C. for 3.25 hours and then cooled to room temperature. Ethanol (375 g) was added as the solvent. Bisphenol A diglycidyl ether (84.8 g, 0.25 mol) and 1,4-butanediol diglycidyl ether (46.4 g, 0.23 mol) were added over a period of 10 minutes. The temperature was kept at 70° C. for 1 hour and then cooled. The reaction mixture was diluted with ethanol according to Table 1. The number average molecular weight M_{N} was 604 (GPC).

### Example 2

0.38 mol mXDA and 0.19 mol ethanolamine were mixed in a flask, with stirring, and heated to a temperature of 60° C. 0.35 mol ethyl acrylate was added over a period of 80 minutes. The reaction temperature was raised to 135° C. and kept there for 1 hour. The ethanol thus formed was distilled off over a period of 5-6 hours, whereupon the temperature was raised to 170° C. until approximately 90% of the theoretical amount was measured. The mixture was subsequently cooled to RT. Bisphenol A diglycidyl ether (0.08 mol) was added over a period of approximately 30 minutes. The temperature was brought to 70° C. and kept there for 1 hour. The product was cooled to RT. Some ethanol may optionally be added to adjust the viscosity.

### Example 3

A procedure analogous to Example 2 was followed, but instead of the bisphenol A diglycidyl ether, a mixture of 0.08 mol each bisphenol A diglycidyl ether and butylene glycol-1,4-diglycidyl ether was used.

### Example 4

The method according to Example 2 was repeated with the following quantities: ethanolamine: 0.17 mol; mXDA: 0.35 mol; ethyl acrylate: 0.39 mol; bisphenol A diglycidyl ether: 0.09 mol.

### Example 5

0.5 mol ethyl acrylate and 1.0 mol mXDA were reacted analogously to Example 1. After distilling off the ethanol and cooling to RT, 145 g ethanol (as solvent) was added. 4.5 mol butylene glycol 1,4-diglycidyl ether was added over a period of 10 minutes. The temperature of 70° C. was maintained over a period of 30 minutes. 5.0 mol Jeffamine T-403 was added within 3 minutes, and stirring was performed for 2 hours. The mixture was then kept at 50° C. for 1 hour.

The number-average molecular weight M_{N} was 600 (GPC).

### Comparative Example

The production was carried out as described in Example 1, but without the use of polyepoxides, and using the following amounts:

3.13 kg (22.97 mol) meta-xylylenediamine (mXDA); 1.22 kg (12.15 mol) ethyl acrylate. The number average molecular weight M_{N} was 600 (GPC).

Adhesive Bondings

Butanediol diglycidyl ether (curing agent 1) or tetraglycidyl-mXDA (curing agent 2) was used as component A. After application, the solvent was removed in a drying tunnel at an elevated temperature (40-70° C.) and with air circulation before the substrates were glued.

| Adhesive | | | | | |
|---|---|---|---|---|---|
| (percentage | | | | | Amount |
| amounts in % by | | | Adhesion | OTR | B:A |
| weight) | Curing agent | Film | N/15 mm | cm³/dm²bar | (weight) |
| Commercially | Isocyanate | OPA/PE | | 26 | |
| available two- | curing agent | | | | |
| component PU | | | | | |
| adhesive | | | | | |
| Example 1 | Curing agent 2 | OPA/PE | 1 | 15 | 3.6:1 |
| (50% in EtOH) | | | | | |
| Example 1 | Curing agent 2 | OPA/PE | 1.1 | 16 | 3.5:1 |
| (60% in EtOH) | | | | | |
| Example 4 | Curing agent 2 | OPA/PE | 1 | 7 | 6.4:1 |
| (65% in EtOH) | | | | | |
| Example 2 | Curing agent 2 | OPA/PE | | 11 | 5.5:1 |
| (65% in EtOH) | | | | | |
| Example 5 | Curing agent 1 | OPA/PE | 2.2 | 15 | 1:0.2 |
| (50% in EtOH) | | | | | |
| Example 5 | Curing agent 2 | OPA/PE | 3.1 | 14 | 1:0.17 |
| (50% in EtOH) | | | | | |
| Commercially | Isocyanate | PET/PE | | 115 | |
| available two- | curing agent | | | | |
| component PU | | | | | |
| adhesive | | | | | |
| Example 1 | Curing agent 1 | PET/PE | 1.3 | 78 | 7.5:1 |
| (50% in EtOH) | | | | | |
| Example 2 | Curing agent 1 | PET/PE | 2.8 | 80 | 6.5:1 |
| (50% in EtOH:EtOAc) | | | | | |
| Example 3 | Curing agent 1 | PET/PE | 3.2 | 80 | 7.2:1 |
| (50% in EtOH:EtOAc) | | | | | |
| Example 5 | Curing agent 2 | PET/PE | | 83 | 5.5:1 |
| (50% in EtOH) | | | | | |
| Without coating | | PET | | 116 | ./. |
| Example 1 as coating | Curing agent 1 | PET | | 93 | 75:1 |

It can be seen that the diffusion values (oxygen transmission rate=OTR) are better with a coating according to the invention than for the film by itself. It is also found that the diffusion value is also lower in the glued substrates. In addition, good adhesive bonding is achieved.

Mechanical Properties:

The amino compound of the comparative example was dissolved in ethanol (60% by weight solids content) and mixed with curing agent 2 (1:0.313). This mixture was poured into a mold made of PTFE (area: 100 mm×100 mm), forming a film 1 mm thick after drying and curing. Additional films were produced on the basis of the following examples from the above table:
Example 1+curing agent 1
Example 1+curing agent 2
Example 2+curing agent 3
Example 5+curing agent 2

The films were released from the mold after one day and were dried for one more day. The films were then bent (180°). The film based on the comparative example and curing agent 2 broke in the process, but the films according to the invention did not. The examples according to the invention thus show improved flexibility.

Pot Life/Exothermy

The adhesive and curing agent were placed in a wide-neck flask at room temperature (24° C.), and the evolution of heat was tracked via the temperature curve over time. The following compositions were produced and tested:

a) The amine component of the comparative example was dissolved in ethanol (50% by weight solids content) and mixed with curing agent 1 (1:0.31).

b) The amine component of Example 1 was dissolved in ethanol (50% by weight solids content) and mixed with curing agent 1 (1:0.27).

In case a), the temperature increase of up to 40° C. is much greater than in case b) of only 33° C. maximum. The higher reactivity in case a) may lead to premature curing of the mixture in the storage container of the lamination machine. In fact, the composition according to the invention according to case b) had a pot life (i.e., the maximum period of time during which processing of the composition is still possible after combining the components) of more than 4 hours, whereas at an even earlier point in time, the composition according to case a) showed an increase in viscosity that would no longer allow good processing.

### Measurement Methods:

Molecular Weight:

The number-average molecular weight M_{N} was determined by gel permeation chromatography (GPC):

Standard: polystyrene standard from PSS

Columns: PLgel 50 Å, 100 Å and Ultrastyragel 500 Å eluent, each 7.8×300 mm and 5 μm (Polymer Laboratories and Waters)

Column oven temperature: 85° C.

Eluent: N-dimethylacetamide with 1 g/L lithium chloride

Flow rate: 1.0 mL/min

Detector: refractive index detector; sensitivity 16, 35° C.

Injection volume: 100 μL

200±10 mg of the sample (6× measurement) was weighed in a 25-mL graduated cylinder, dissolved while adding the eluent, and the graduated cylinder was then topped off with eluent up to the mark. The sample thus produced was filtered through a 0.45-μm syringe filter into a sample container. The molecular weight determination is based on an external calibration (third-order polynomial) with the aid of the aforementioned narrow distribution polystyrene standard from PSS.

Compound Adhesion:

Using a strip cutter, 15 mm-wide strips of the composite were cut. The composite was then separated by hand or on a hot sealing jaw edge. It may optionally be helpful to insert one end of the composite strip into ethyl acetate. The measurement was performed using a universal tensile testing machine, force range 0-20 N (e.g., from Instron or Zwick). The composite strips that were previously separated were clamped in, and the tensile testing machine was started up at a draw-off rate of 100 mm/min. The draw-off angle was 90° (to be maintained manually) and the draw-off length was 5-10 cm (depending on the range of fluctuation). The measurement was repeated three times. Compound adhesion was obtained as the average of these three measurements.

Oxygen Permeability (Oxygen Transmission Rate (OTR))

OX-TRAN 2/21 H measuring devices from MOCON were used to determine the oxygen permeability. The test cell of the measuring instruments consists of two halves. The film was mounted between the two half-cells. Oxygen as the test gas was passed through the outer half-cell. Carrier gas, a mixture of 95% nitrogen and 5% hydrogen (essentially forming gas) flowed through the inner half-cell. Oxygen penetrating through the film is picked up by the carrier gas and conveyed to the detector. The oxygen sensor generates an electric current in the presence of oxygen, this current being proportional to the amount of oxygen arriving.

Viscosity:

The viscosity was determined at the stated temperature in accordance with the ISO 2555 standard, with the aid of a Brookfield LVT viscometer. The choice of the spindle and shear rate depends on the temperature and the viscosity range (e.g., at RT up to ˜30° and viscosities of approximately 1000-5000 mPas, spindle 27 and a shear rate of 5 rpm are suitable).

What is claimed is:

1. A two-component composition composed of a component A containing epoxides having a number average molecular weight (M_{N}) of 150 to 5000 g/mol with at least two epoxy groups per molecule, a component B containing a reaction product produced from araliphatic polyamines and optionally additional amines, unsaturated carboxylic acids and/or derivatives thereof and aliphatic and/or aromatic polyepoxides in a molar ratio of amine to the sum total of unsaturated carboxylic acid and/or its derivatives and polyepoxide of 1:0.4 to 1:0.95 to yield a product containing a primary amino group and having a number average molecular weight (M_{N}) of less than 5000 g/mol.

2. The two-component composition according to claim 1, wherein aliphatic and/or aromatic polymers having epoxy groups are used as component A.

3. The two-component composition according to claim 1, wherein mixtures of aliphatic and aromatic polyepoxides, in particular diepoxides, are used as a building block in component B.

4. The two-component composition according to claim 1, wherein the sum total of epoxide components in A and B contains between 10 and 50% by weight aliphatic epoxide building blocks.

5. The two-component composition according to claim 1, wherein ethanolamine is used as an additional amine in an amount of up to 50 mol %, based on the sum total of araliphatic polyamine and ethanolamine.

6. The two-component composition according to claim 1, wherein components A and B are mixed in a molar ratio of primary amino groups in component B to epoxy groups in component A of 0.75:1 to 1.25:1.

7. The two-component composition according to claim 1, wherein component A contains epoxides selected from poly(meth)acrylates, polyolefins, polybutadienes, polyesters, polyamides, polyurethanes, and aliphatic and/or aromatic polyepoxide resins containing epoxy groups.

8. The two-component composition according to claim 1, wherein the composition contains additional homogeneously miscible, nonreactive polymers, in particular derivatives of oligosaccharides or polysaccharides.

9. The two-component composition according to claim 1, wherein the composition contains C₁ to C₄ alcohols or water as the solvent, or is essentially free of other organic solvents.

10. Cured reaction products of the two-component composition according to claim 1.

11. A two-component lamination adhesive containing a composition according to claim 1 for gluing films and paper.

12. A lamination comprising at least two layers of film or paper bonded by the two-component lamination adhesive according to claim 10.

13. A two-component coating agent containing a composition according to claim 1 for coating films and paper.

14. A substrate coated with the two-component coating agent according to claim 12.

15. A foodstuff or medical package comprising two adjacent films bonded by a lamination adhesive containing a composition according to claim 1.

16. A foodstuff or medical package comprising a film substrate coated with a mixture containing a composition according to claim 1.
